(19) United States
(12) Patent Application Publication
(10) Pub. No.: US 2009/0105024 A1
(43) Pub. Date: Apr. 23, 2009

(54) CHAIN TRANSMISSION

(75) Inventors: Shunji Sakura, Osaka (JP); Akira Hirai, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/195,719

(22) Filed: Aug. 21, 2008

(30) Foreign Application Priority Data
Oct. 22, 2007 (JP) 2007-274323

(51) Int. Cl. F16H 7/06

(52) U.S. Cl. 474/156

(57) ABSTRACT

A hybrid chain comprises outer links composed of link plates connected in side-by-side relationship by two connecting pins fitted to holes in the outer plates, and inner links composed of link plates in spaced, side-by-side relationship and connected by two bushings on which rollers are mounted, the bushings being fitted to holes in the inner plates. The inner and outer links are connected in alternating, overlapping, relationship, with each pin of an outer link extending through a bushing of an adjacent overlapping inner link. The chain meshes with a sprocket composed of a central sprocket engaged by the rollers, and two side sprockets. The inner link plates, the outer link plates, or both, have two teeth, with outer flanks in the form of arcs each centered on the more remote pin or bushing hole. The inner link plates, outer link plates, or both, can be double-sided link plates.

### CROSS-REFERENCE TO RELATED APPLICATION

This application claims priority on the basis of Japanese patent application 2007-274323, filed Oct. 22, 2007. The disclosure of Japanese application 2007-274323 is hereby incorporated by reference.

### FIELD OF THE INVENTION

The invention relates to a chain transmission for transmitting power, in which an endless chain is engaged with a driving sprocket and one or more driven sprockets. A chain transmission is typically used in an internal combustion engine as a timing chain or for driving auxiliary equipment such as an oil pump. The invention relates particularly to a chain transmission incorporating a hybrid chain, which combines the functions of a roller chain and a silent chain.

### BACKGROUND OF THE INVENTION

Chain transmissions utilizing roller chains, and chain transmissions utilizing silent chains, are well known. It is also known to incorporate into a chain transmission a composite chain in which the features of a roller chain and a silent chain are combined. Such a chain transmission is described in Japanese Examined Patent Publication No. 59-30936, and illustrated in FIG. 7. This composite chain 31 is composed of a roller chain 33, with silent chains 32 on both sides, the links of all three chains being connected by connecting pins 35.

A conventional silent chain has advantages over a roller chain in that it exhibits greater strength produced less noise. However, since the connecting pins rotate relative to the pin holes of the inner link plates of the chain, elongation of a silent chain due to wear of the connecting pins in the silent chain is usually greater than the elongation of a roller chain.

On the other hand, a roller chain exhibits superior fatigue strength and resistance to wear elongation. However, increasing the strength of a roller chain is difficult because it requires increasing the strength of the rollers, which results in greater meshing noise because, at the time of engagement, the rollers directly engage the a bottoms of the gaps between sprocket teeth.

In the conventional composite chain transmission, the roller chain component comprises four link plates arranged widthwise in the chain, and the two silent chain components comprise at least four additional link plates in the widthwise direction. Consequently the composite chain is wide and has a large mass. Furthermore, the outer flanks of link plate teeth in the silent chain components are not arcuate in shape. The outer flanks tend to bite the sprocket teeth, and do not easily disengage from the sprocket teeth.

This invention addresses the problems described above, and provides a composite chain transmission which exhibits the advantages of both a silent chain and a roller chain, reducing wear elongation, reducing weight, and exhibiting high strength and reduced noise.

### SUMMARY OF THE INVENTION

The chain transmission according to the invention comprises a hybrid chain formed into an endless loop and a composite sprocket in meshing engagement with the chain.

The chain comprises a set of inner links each composed of a pair of inner link plates arranged in spaced, side-by-side, relationship, and a set of outer links each composed of a pair of outer link plates also disposed in spaced, side-by-side, relationship. The inner link plates of each pair are connected by two bushings, each bushing having a roller rotatable thereon and being fixed in one of two holes in each inner link plate of the pair. The outer link plates of each pair are connected by two pins, each pin being fixed in one of two holes in each outer link plate of the pair. The inner links and the outer links are disposed in alternating, overlapping, relationship along the length of the chain, with each pin of each outer link extending rotatably through a bushing of an overlapping inner link.

Each of the link plates of least one of the sets of inner and outer links is a toothed link plate having a pair of teeth. The outer flank of each tooth of each toothed link plate is in the form of an arc concentric with the more distant of the two holes in the same link plate. The composite sprocket includes a central sprocket and side sprockets disposed on both sides of the central sprocket. The rollers of the hybrid chain are arranged to mesh with the central sprocket, and the toothed link plates are arranged to mesh with the side sprockets.

In one embodiment of the chain transmission, all of the link plates of the outer and inner links of the hybrid chain are toothed link plates, each having a pair of teeth, and the outer flank of each tooth of each link plate is in the form of an arc concentric with the more distant of the two holes in the same link plate.

In another embodiment of the chain transmission, the link plates of only one of the sets of inner and outer links in the hybrid chain are toothed link plate, and the link plates of the other set are substantially oval-shaped link plates having no teeth.

In still another embodiment, the toothed link plates of the chain are double-sided toothed link plates, each having a first pair of teeth protruding toward the inside of the loop formed by the chain and a second pair of teeth protruding toward the outside of the loop. In each double-sided toothed link plate the outer flank of each tooth is in the form of an arc concentric with the more distant of the two holes in the same link plate.

Preferably, the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket.

In the chain according to the invention, the surface pressures on the connecting pins and bushings are small, and the links of the chain flex smoothly, so that wear elongation of the chain is suppressed. Furthermore, since the hybrid chain is composed of outer and inner links, each having only two link plates, at any location along the length of the chain there are only four link plates overlapping one another in the widthwise direction. Accordingly, the hybrid chain according to the invention can be narrower, and lighter in weight, than a conventional composite chain, and can be produced at a lower cost.

Where the outer flanks of the teeth of each toothed plate are in the form of arcs centered on the more distant pin hole or bushing hole in the same plate, the toothed link plates engage the teeth of the side sprockets before the adjacent roller engages the teeth of the central sprocket. Thus, the impact on engagement of a roller with the central sprocket is reduced, and noise and vibration are suppressed.

When all the link plates are toothed link plates, the outer flanks of all the link plate teeth sequentially and continuously come into contact with side sprocket teeth, and chordal vibration and noise are more effectively suppressed.

When both outer flanks of the pair of teeth of a link plate are in the form of an arc centered on the more distant pin hole or bushing hole in the link plate, not only is the engagement of the link plate with the side sprockets made smooth, but, at the same time, because the outer flanks come into contact with the side sprocket teeth along the arcs of their outer flanks, the outer flanks contact the side sprocket teeth with a uniform force from the start of engagement to the completion of engagement.

Since the outer flanks of the toothed link plates arcuate in shape, biting is avoided, and smooth disengagement of the link teeth from the sprocket teeth is ensured.

When the link plates in one of the two sets of links are toothed link plates and the other link plates are oval-shaped link plates without teeth, a further reduction in the overall weight of the hybrid chain can be realized.

Where the link plates have outwardly facing teeth as well as inwardly facing teeth, the hybrid chain can be used as a double-sided chain.

Where the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated on a gap between teeth on he sprocket, a reduction in noise can be realized, and wear of the side sprocket teeth can be suppressed. Moreover, since the rollers are seated on sprocket teeth while the adjacent link plates are seated, the fatigue strength of the chain can be as high as that of a roller chain.

### BRIEF DESCRIPTION OF THE DRAWINGS

FIG. 1 is a plan view, partly in section, of a portion of a hybrid chain used in chain transmission according to the invention;

FIG. 2 is an elevational of a sprocket of the chain transmission;

FIG. 3 is a perspective view showing the hybrid chain of FIG. 1 engaged with the sprocket of FIG. 2;

FIG. 4 is a schematic elevational view illustrating the manner in which the hybrid chain engages the sprocket of FIG. 2;

FIG. 5 is an enlarged view of a portion of the chain and sprocket outlined by a circle M FIG. 4;

FIG. 6a is an elevational a toothed link plate used in the chain;

FIG. 6b is a side elevational view of an oval link plate having no teeth;

FIG. 6c is a side elevational view of a double-sided toothed link plate; and

FIG. 7 is a plan view of a part of a conventional composite chain.

### DETAILED DESCRIPTION OF THE PREFERRED EMBODIMENTS

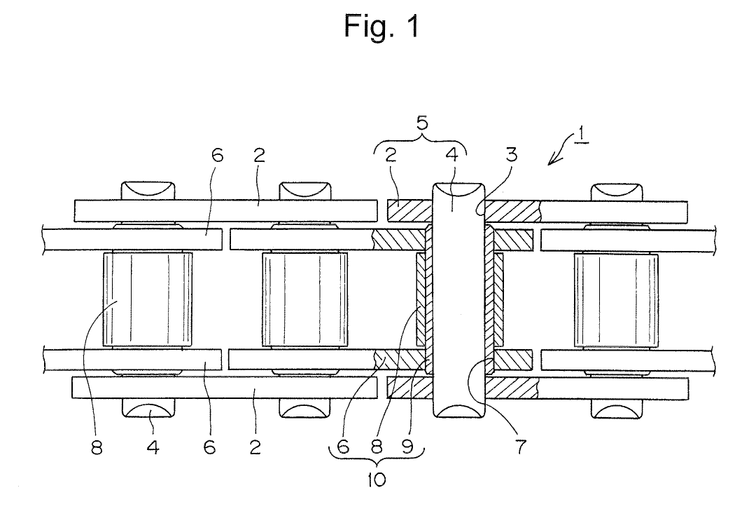

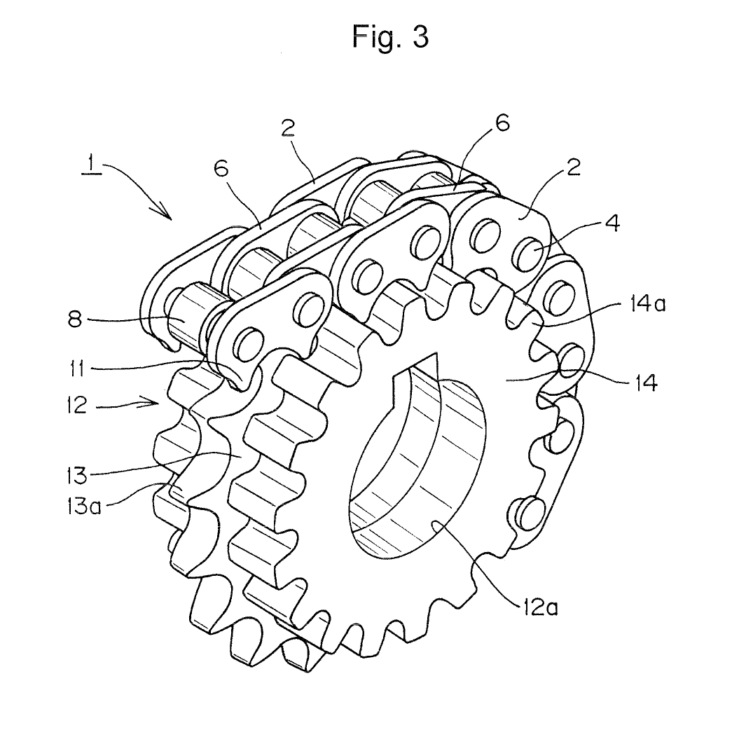

In a chain transmission according to a first embodiment of the invention, which will be described with reference to FIGS. 1-6a, all of the link plates forming outer links 5 and inner links 10 of an endless hybrid chain 1 are toothed link plates. Link plates 2 are outer link plates, and link plates 6 are inner link plates. As shown in FIG. 1, both ends of a connecting pin 4 are fitted into pin holes of a pair of outer link plates 2, and thereby secured in fixed relationship to the outer link plates. A bushing 9 is similarly fitted into bushing holes in a pair of inner link plates 6, and thereby secured in fixed relationship to the inner link plates. A roller 8 is loosely fitted and rotatable on the bushing 9. The connecting pin 4 extends rotatably through the bushing, and the outer link 5 is thereby connected in articulating relationship to an adjacent inner plate 10. The two pins of each outer link extend respectively through bushings in two adjacent inner links. Thus, the chain is formed into an endless loop composed of alternating inner and outer links.

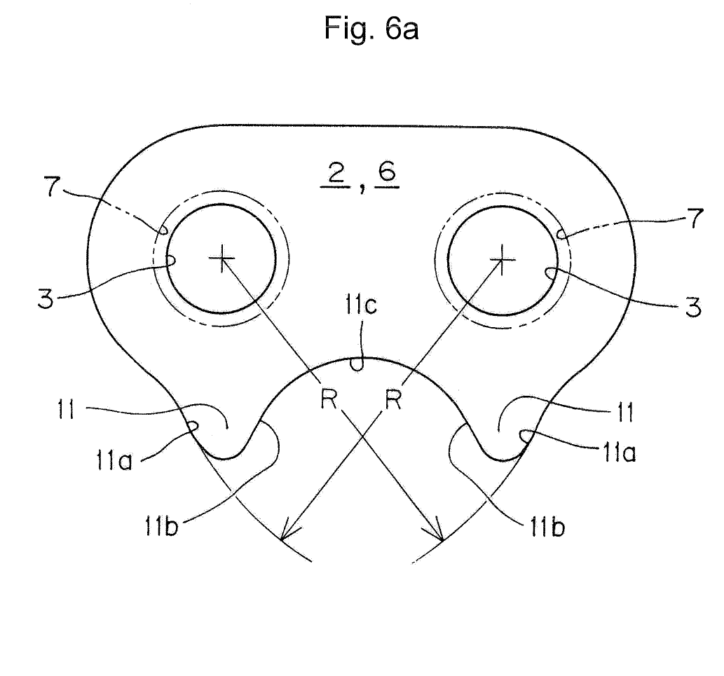

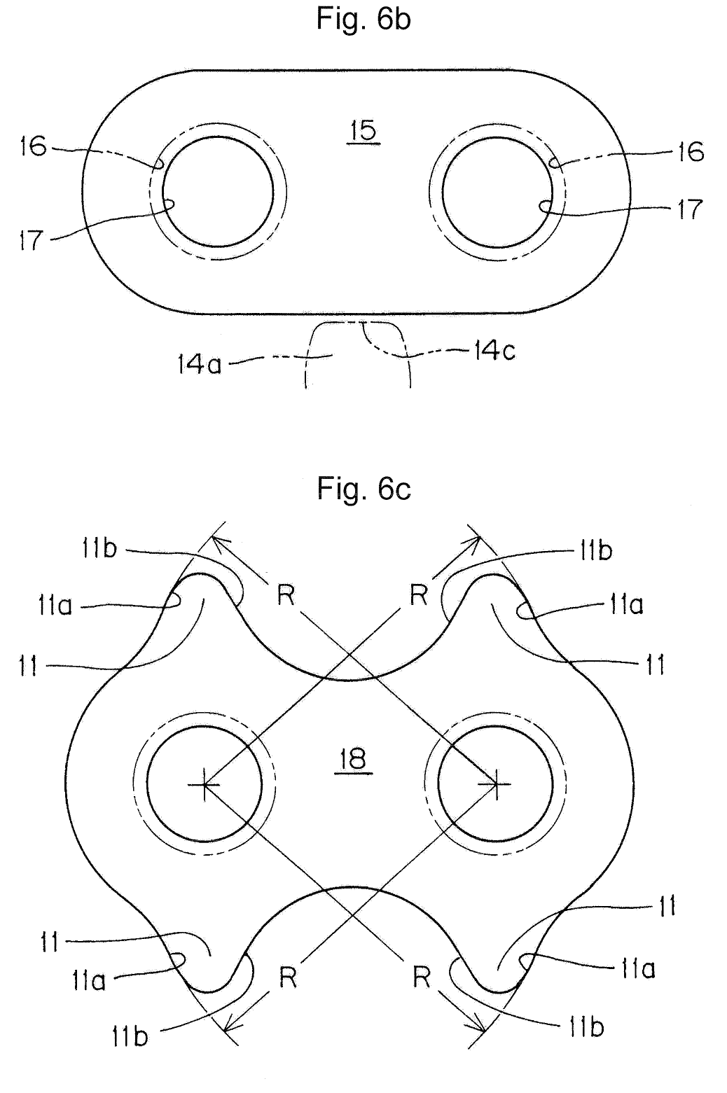

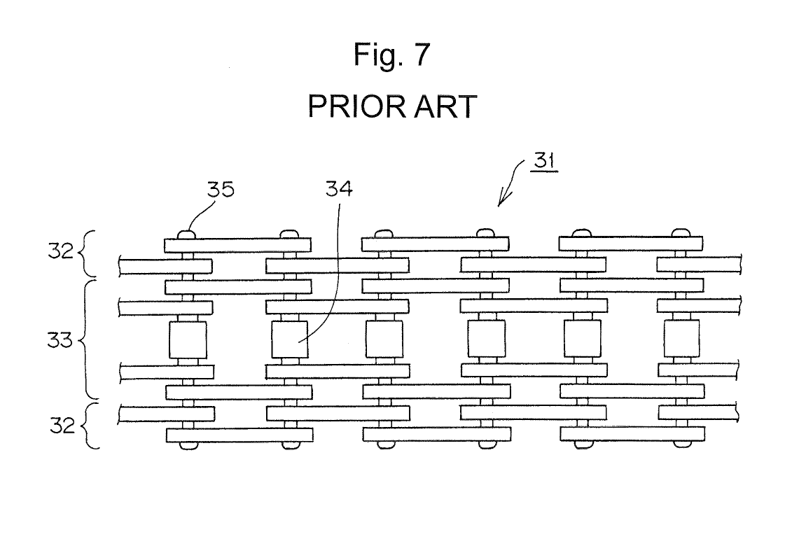

The outer link plates 2 of the outer links 5 and the inner link plates 6 of the inner links 10 are toothed plates having the same contour, and differ only in the sizes of the holes. Thus, as shown in FIG. 6a, outer plates 2 have small holes 3, into which connecting pins are press-fit, and inner plates 6 have larger holes 7, into which bushings are press-fit.

Each plate has a pair of “siamese” teeth 11, as shown in FIG. 6a. These teeth have outer flanks 11a on both and inner flanks 11b. Each of the outer flanks 11a is in the form of an arc having a radius R, and centered on the center of the more distant of the two pin holes 3 or bushing holes 7 in the plate.

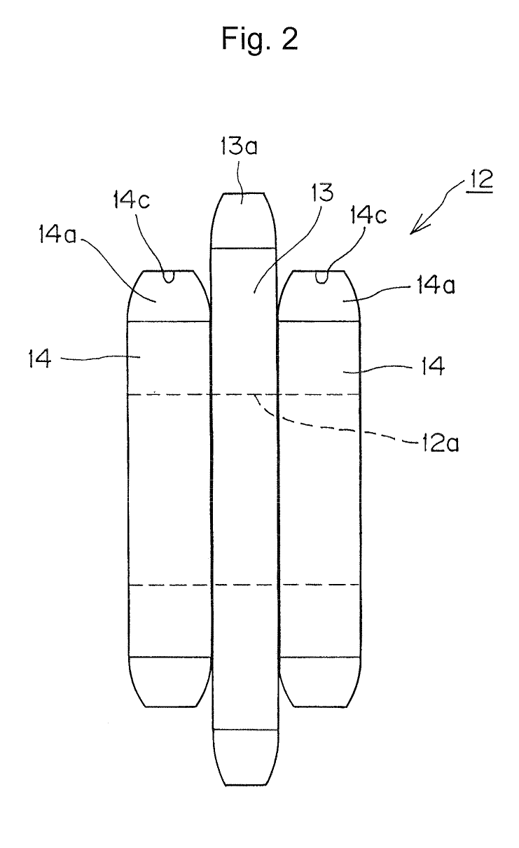

As shown in FIG. 2, a composite sprocket 12, which, in the transmission, is in meshing engagement with the hybrid chain 1, includes a central sprocket 13, for engagement with a roller 8 of the chain, and side sprockets 14, on both sides of the central sprocket so that the central sprocket is sandwiched between the two side sprockets. The side sprockets 14 engage teeth 11 of the respective toothed link plates 2 and 6.

As shown in FIG. 2, the tooth heads of the central sprocket 13 protrude radially outward farther than the tooth heads of the side sprockets. The chain transmission is formed by engaging a hybrid chain with a first composite sprocket 12 which serves as a driving sprocket, and with one or more similar composite sprockets which serve as driven sprockets. Each sprocket has a shaft hole 12a. The teeth of the central sprocket can have standard tooth forms following suitable standards, for example the ISO (International Standards Organization) standards, or the JIS (Japanese Industrial Standards). Alternatively, the teeth of the central sprocket can have other tooth forms, including random phase tooth forms. The teeth of the side sprockets 14 are preferably involute teeth, but can have various other shapes with which the outer flanks 11a of the link plate teeth can mesh by sliding engagement.

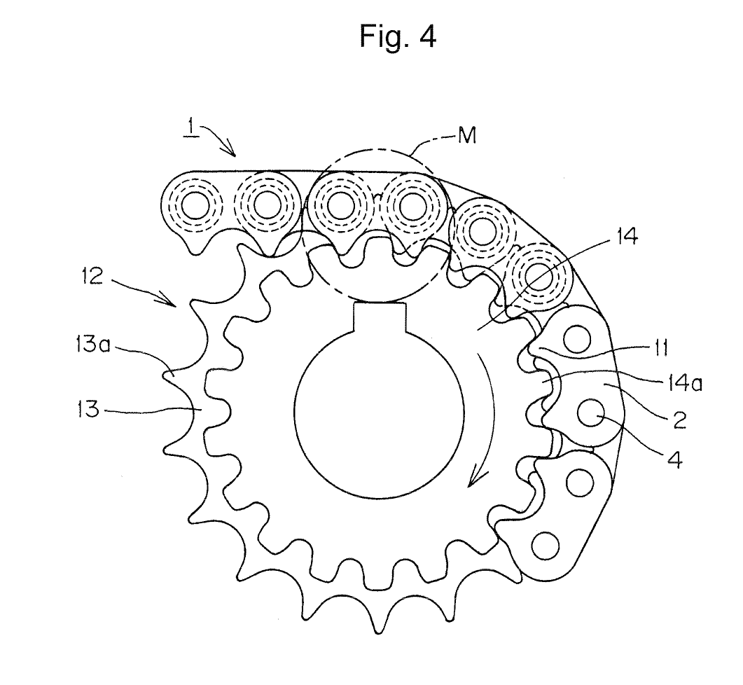

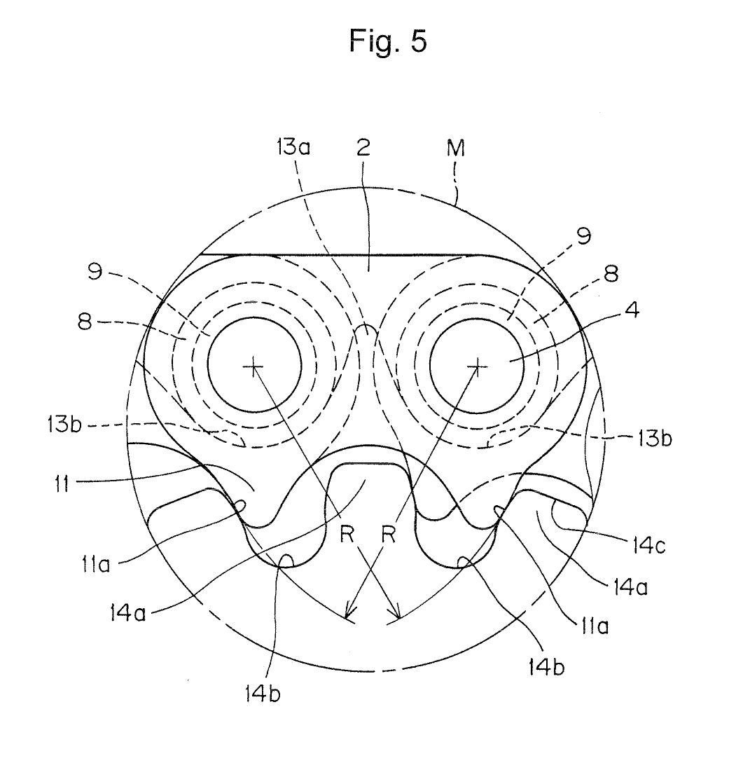

As the composite sprocket 12 rotates and the chain 1 advances toward the sprocket, the teeth 11 of the outer and inner link plates 2 and 6 engage with the side sprockets 14 in the same manner. As shown in FIGS. 4 and 5, the teeth 11 which, on a given link plate, are the rearward teeth with reference to the direction of advancement of the chain, begin to engage teeth 14a of the side sprockets 14, coming into contact with the sprocket teeth along the arcs of outer flanks 11a. The chain 1 winds around the composite sprocket as the inner and outer link plates 2 rotate respectively about the axes of the connecting pins and bushings. As the rearward teeth 11 of the link plates slide on sprocket teeth 14a toward the tooth gap bottoms 14b, the outer flanks 11a of the forward teeth 11 contact sprocket teeth 14a. After the rearward tooth begins to slide on a sprocket tooth, the roller 8 adjacent the rearward tooth comes into contact with a tooth 13a of the central sprocket 13 and becomes seated on a tooth gap bottom 13b. At the same time, the link plates become seated on sprockets 14.

The engagement of the inner link plates with the sprocket is identical to the engagement of the outer link plates with the sprocket. During engagement and seating, neither the inner flanks 11b nor the crotch 11c come into contact with the teeth 14a of the side sprockets 14.

In the hybrid chain, since the outer links and the inner links are connected by connecting pins 4 of the outer links which fit rotatably in bushings 9 of the inner links, the surface pressures exerted on the connecting pins and bushings are small, and the inner and outer links flex smoothly so that wear elongation of the chain is suppressed.

Since the hybrid chain is composed of outer links 5 and inner links 10, each having only two link plates, at any location along the length of the chain there are only four link plates overlapping one another in the widthwise direction. Accordingly, the hybrid chain according to the invention can be narrower, and lighter in weight, than a conventional composite chain, and can be produced at a lower cost.

When both the outer and inner links of the hybrid chain are composed of toothed inner, as the chain meshes with the composite sprocket, teeth 11 of the toothed link plates engage teeth 14a of the side sprockets before an adjacent roller 8 the central sprocket, so that the impact on engagement with of the roller with the central sprocket is reduced, and noise and vibration are suppressed. Furthermore, when the hybrid chain 1 is wound around the composite sprocket 12, outer flanks 11a of the teeth of all the toothed inner and outer link plate plates sequentially and continuously come into contact with side sprocket teeth 14a to start engagement therewith. As a result, chordal vibration and noise are further suppressed.

In both the inner and outer link plates 6 and 2, both outer flanks of the pair of teeth 11 are in the form of an arc centered on the more distant pin hole or bushing hole in the same plate. As a result, smooth engagement of the link plates with the side sprockets can be realized. In addition, because the teeth 11 engage the side sprocket teeth along the arcs of the outer flanks, the outer flanks contact the side sprocket teeth with a constant force from the start of engagement to the completion thereof.

In addition, because the outer flanks of the inner and outer link plates have an arcuate shape, the teeth of the link plates are not liable to be bitten and therefore smooth disengagement can be obtained. Further, since the outer flanks 11a of each plate are in the form of arcs, each centered on the more distant pin hole or bushing hole, contact along the arc of the outer flank 11a with a sprocket tooth 14a can be synchronized with the movement of the adjacent roller 8 as it engages a central sprocket tooth 13a.

In a second embodiment of the invention, the composite sprocket 12 and the outer links are the same as in the previously described embodiment. Connecting pins 4 are secured in pin holes 3 of a pair of toothed outer link plates 2 as in FIG. 6a. However, the inner link plates are substantially oval-shaped link plate 15, as shown in FIG. 6b, having no teeth. These oval link plates are similar to the link plates usually used in a roller chain. The inner links are obtained by fitting bushings, on which rollers are rotatably mounted, into bushing holes of a pair of substantially oval-shaped link plates 15.

Each outer link plate 2 has a pair of “siamese” teeth 11, as shown in FIG. 6a. These teeth have outer flanks 11a on both and inner flanks 11b. Each of the outer flanks 11a is in the form of an arc having a radius R, and centered on the center of the more distant of the two pin holes 3 in the plate.

In summary the hybrid chain of the second embodiment comprises outer links 5 having toothed outer link plates 2, and inner links having substantially oval-shaped link plate 15 without teeth.

In the hybrid chain of the second embodiment, the toothed outer link plates engage the side sprocket. However, the substantially oval-shaped link plates 15 closely approach, but do not contact, the tooth heads 14c of the side sprockets 14, as illustrated in FIG. 6b.

In this second embodiment, as the composite sprocket 12 rotates and the chain advances toward the sprocket, the teeth 11 of the outer link plates 2 engage the side sprockets. The rearward teeth 11 begin to engage teeth 14a of the side sprockets 14, coming into contact with the sprocket teeth along the arcs of their outer flanks 11a. As the chain winds around the composite sprocket, the outer link plates 2 rotate about the axes of the bushings in the inner links. As the rearward teeth 11 of the outer link plates slide on sprocket teeth 14a toward the tooth gap bottoms 14b, the outer flanks 11a of the forward teeth 11 contact their adjacent sprocket teeth 14a. After the rearward tooth begins to slide on a sprocket tooth, the roller 8 adjacent the rearward tooth comes into contact with a tooth 13a of the central sprocket 13 and becomes seated on a tooth gap bottom 13b. At the same time, the outer link plates become seated on sprockets 14. Thus, the rollers 8 seat on tooth gap bottoms 13b of the central sprocket, and outer flanks 11a of the teeth 11 of the outer link plates 2 are brought into seating contact with teeth 14a of the side sprockets 14. As in the first embodiment, during engagement and seating, neither the inner flanks 11b nor the crotch 11c of the outer link plates come into contact with the teeth 14a of the side sprockets 14.

In a third embodiment of the invention, the outer links are composed of substantially oval-shaped link plates similar to that shown in FIG. 6b, while the inner links are composed of toothed link plates corresponding to the link plate shown in FIG. 6a. Here, in the outer links, two side-by-side, spaced, oval link plates are connected by connecting pins fitted to pin holes in the link plates, and the toothed link plates of the inner links are connected by bushings fitted to bushing holes in the toothed link plates. The structure is thus similar to that of the second embodiment except that the toothed and oval link plates are interchanged, and their holes are sized appropriately to fit bushings and pins respectively.

In summary, the hybrid chain of the third embodiment comprises inner links composed of toothed inner link plates, and outer links composed of substantially oval-shaped link plates having no teeth.

The toothed link plates of the inner links engage with the side sprockets 14. The substantially oval-shaped link plates of the outer links, which have no teeth, closely approach, but do not contact, the tooth heads of the sprocket teeth as shown in FIG. 6b.

In this third embodiment, as the composite sprocket 12 rotates and the chain advances toward the sprocket, the teeth 11 of the inner link plates 6 engage the side sprockets. The rearward teeth 11 begin to engage teeth 14a of the side sprockets 14, coming into contact with the sprocket teeth along the arcs of their outer flanks 11a. As the chain winds around the composite sprocket, the inner link plates 6 rotate about the pins of the outer links. As the rearward teeth 11 of the outer link plates slide on sprocket teeth 14a toward the tooth gap bottoms 14b, the outer flanks 11a of the forward teeth 11 contact their adjacent sprocket teeth 14a. After the rearward tooth begins to slide on a sprocket tooth, the roller 8 adjacent the rearward tooth comes into contact with a tooth 13a of the central sprocket 13 and becomes seated on a tooth gap bottom 13b. At the same time, the inner link plates become seated on sprockets 14. Thus, the rollers 8 seat on tooth gap bottoms 13b of the central sprocket, and outer flanks 11a of the teeth 11 of the inner link plates 6 are brought into seating contact with teeth 14a of the side sprockets 14. As in the first and second embodiments, during engagement and seating, neither the inner flanks 11b nor the crotch 11c of the outer link plates come into contact with the teeth 14a of the side sprockets 14.

In the second and third embodiments, since either the inner links or the outer links are composed of substantially oval-shaped link plates having no teeth, a reduction in the overall weight of the hybrid chain can be realized.

A fourth embodiment of the chain transmission uses double-sided toothed link plates 18, as shown in FIG, 6c, each having a pair of teeth 11 protruding toward the outside of the loop formed by the chain as well as a pair of teeth 11 protruding toward the inside of the loop. The pair of teeth protruding toward the inside of the loop have the same configuration as in FIG. 6a. That is, the outer flanks 11a are in the form of arcs having a radius R, each arc being centered on the more remote pin hole or bushing hole. The teeth 11 that protrude toward the outside of the loop also have outer flanks 11a, each in the form of an arc having a radius R, centered on the more remote pinhole or bushing hole. The teeth have inner flanks 11b similar to the inner flanks of the teeth shown in FIG. 6a.

The hybrid chain of the fourth example can have double-sided toothed link plates as its inner link plates, or as its outer link plates, the other link plates being oval-shaped link plates as in FIG. 6b. Alternatively, both the inner and outer link plates can be double-sided link plates as in FIG. 6c. The hybrid chain according to the fourth embodiment can engage with a composite sprocket on the outside of the loop formed by the chain as well as with two or more sprockets on the inside of the loop.

We claim:

1. A chain transmission comprising:
a hybrid chain formed into an endless loop, the chain comprising a set of inner links each composed of a pair of inner link plates arranged in spaced, side-by-side, relationship, the inner link plates of each pair being connected by two bushings, each bushing having a roller rotatable thereon and being fixed in one of two holes in each inner link plate of the pair, and a set of outer links each composed of a pair of outer link plates also disposed in spaced, side-by-side, relationship, the outer link plates of each pair being connected by two pins, each pin being fixed in one of two holes in each outer link plate of the pair, the inner links and the outer links being disposed in alternating, overlapping, relationship along the length of the chain, with each pin of each outer link extending rotatably through a bushing of an overlapping inner link; and
a composite sprocket in meshing engagement with said chain;
wherein each of the link plates of least one of the sets of inner and outer links is a toothed link plate having a pair of teeth, and the outer flank of each tooth of each said toothed link plate is in the form of an arc concentric with the more distant of the two holes in the same link plate; and
wherein said composite sprocket includes a central sprocket and side sprockets disposed on both sides of the central sprocket, the rollers of said hybrid chain are arranged to mesh with the central sprocket, and the toothed link plates are arranged to mesh with the side sprockets.

2. A chain transmission according to claim 1, in which all of the link plates of said outer and inner links of the hybrid chain are toothed link plates, each having a pair of teeth, and in which the outer flank of each tooth of each link plate is in the form of an arc concentric with the more distant of the two holes in the same link plate.

3. A chain transmission according to claim 1, in which the link plates of only one of the sets of inner and outer links in the hybrid chain are toothed link plate, and the link plates of the other set are substantially oval-shaped link plates having no teeth.

4. A chain transmission according to claim 1 in which the toothed link plates of the chain are double-sided toothed link plates, each having a first pair of teeth protruding toward the inside of said loop and a second pair of teeth protruding toward the outside of the loop, and in which each, and in which the outer flank of each tooth of the toothed link plate is in the form of an arc concentric with the more distant of the two holes in the same link plate.

5. A chain transmission according to claim 2, in which the toothed link plates of the chain are double-sided toothed link plates, each having a first pair of teeth protruding toward the inside of said loop and a second pair of teeth protruding toward the outside of the loop, and in which each, and in which the outer flank of each tooth of the toothed link plate is in the form of an arc concentric with the more distant of the two holes in the same link plate.

6. A chain transmission according to claim 3, in which the toothed link plates of the chain are double-sided toothed link plates, each having a first pair of teeth protruding toward the inside of said loop and a second pair of teeth protruding toward the outside of the loop, and in which each, and in which the outer flank of each tooth of the toothed link plate is in the form of an arc concentric with the more distant of the two holes in the same link plate.

7. A chain transmission device according to claim 1, in which the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket, and the last-mentioned toothed link plates also become seated on teeth of the sprocket.

8. A chain transmission device according to claim 2, in which the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket, and the last-mentioned toothed link plates also become seated on teeth of the sprocket.

9. A chain transmission device according to claim 3, in which the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket, and the last-mentioned toothed link plates also become seated on teeth of the sprocket.

10. A chain transmission device according to claim 4, in which the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket, and the last-mentioned toothed link plates also become seated on teeth of the sprocket.

11. A chain transmission device according to claim 5, in which the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket, and the last-mentioned toothed link plates also become seated on teeth of the sprocket.

12. A chain transmission device according to claim 6, in which the chain rollers and the sprocket teeth are configured so that, as the teeth and rollers of the chain come into meshing engagement with the sprocket, after the rearmost outer flanks of the teeth of each link comprising toothed link plates engage sprocket teeth, the adjacent roller contacts a sprocket tooth and becomes seated in a gap between teeth on said sprocket, and the last-mentioned toothed link plates also become seated on teeth of the sprocket.
